(19) United States
(12) Patent Application Publication
(10) Pub. No.: US 2024/0248317 A1
(43) Pub. Date: Jul. 25, 2024

(54) OPTICAL WEDGE ELEMENT FOR GLAZING EQUIPPED WITH OPTICAL SENSOR

(71) Applicant: AGC GLASS EUROPE, Louvain-la-Neuve (BE)

(72) Inventors: Meijie LI, Louvain-La-Neuve (BE); Xavier LALOYAUX, Gosselies (BE); Yannick SARTENAER, Vedrin (BE)

(73) Assignee: AGC GLASS EUROPE, Louvain-la-Neuve (BE)

(21) Appl. No.: 18/560,801

(22) PCT Filed: Jun. 23, 2022
(86) PCT No.: PCT/EP2022/067281

§ 371 Date: Nov. 14, 2023

(30) Foreign Application Priority Data
Jun. 29, 2021 (EP) 21182615.1

(51) Int. Cl. G02B 27/09; G01S 7/481; G01S 17/931

(52) U.S. Cl. CPC G02B 27/0972; G01S 7/4811; G01S 17/931

(57) ABSTRACT

A glazing includes an optical sensor facing an internal face of the glazing. An optical wedge element with an optimized wedge angle is placed on the internal face of the glazing, between the glazing and the optical sensor.

### FIELD OF THE INVENTION

The present invention relates to the field of optical sensors placed behind an inclined glazing. More specifically it relates to an optical wedge element placed on the internal face of an inclined glazing. The present invention also relates to a method to rescale the field of view of an optical sensor placed behind an inclined glazing, and more particularly behind an inclined glazing of a vehicle.

### BACKGROUND OF THE INVENTION

Nowadays vehicles are equipped with increasing optical sensors. Vehicles include car, van, lorry, motorbike, bus, tram, train, drone, airplane, helicopter and the like. Besides vehicles, there is also an increasing demand to install optical sensors behind glazing of buildings, also including windmills, oil rigs, road signs, . . . .

Amongst the optical sensors used on a vehicle, there is an increasing request towards emitting and receiving (E/R) optical sensors, meaning optical sensors which first emit signal from the vehicle towards the outside of the vehicle and then receive the signal reflected by some obstacle outside of the vehicle. A lidar is a typical example of such E/R optical sensor. The expressions “emitting and receiving” or “E/R” may both be used throughout the text, and both refers to the same concept.

The trend is towards integrating such E/R optical sensors behind the glazing of the vehicles. As the E/R optical sensor is placed behind a glazing, an important signal loss comes from reflection of the emitted signal on the internal surface of the glazing, meaning the surface of the glazing facing the inside of the vehicle. Such reflection occurs at the air/glazing interface when the light rays are emitted toward the outside. This attenuation impairs the detection by the E/R optical sensor, so that accurate distance measurement is no longer possible.

If the E/R optical sensor is placed behind an inclined glazing of the vehicle, it leads to even more attenuation of the signal. In the case of a windshield, for example, it is installed with an angle between 25° and 40° with the horizontal plane. As the E/R optical sensor is usually placed in the upper part of the windshield and as a windshield may be more curved in its upper part, the angle between the glazing and the horizontal plane is even smaller, typically from 20° to 35°. If the E/R optical sensor is placed horizontally, it therefore means an angle of incidence of the signal on the glazing of 70° to 55° (complementary angle of the angle between the glazing and the horizontal plane). Taking into account a field of view (FOV) of the E/R optical sensor of 30°, it therefore leads to an angle of incidence on the glazing which can be as high as 85°, leading to an important part of the signal being reflected.

One way to decrease such reflection is to coat the internal surface of the glazing with an antireflective (AR) coating. An AR coating can for example be applied by physical vapor deposition (PVD) on the glazing. The AR coating is only required on a small area of the glazing, meaning on the part of the glazing inside the field of view (FOV) of the optical sensor. However, local deposition is quite complex. Therefore, either a full coating is applied, leading to an AR coating on areas requiring no AR coating. Either a masking is required on the whole glass surface except on the dedicated area for the AR coating, which leads to manufacturing constraints. Local deposition can be performed by other technics than PVD, but those techniques usually do not reach the high level optical quality in terms of roughness, uniformity and durability. Besides, standard AR coating is normally optimized for normal incidence. The performance of such AR coating reduces with increased angle of incidence of incident light. Specifically designed AR coating can be optimized for large angle of incidence, but such AR coating are more complex, more expensive and challenging to install. AR coating clearly increases manufacturing difficulty and cost. Moreover it may reduce mechanical, chemical and thermal resistance of the glazing on which it is applied.

Another way to decrease such reflection, as disclosed in WO9419705, is to place a prismatic element with an appropriate refractive index and absorption level on the internal face of the glazing to adapt the incident angle of the beam. Such optical wedge element will decrease the reflection. However, the optical wedge element can be a large piece of material with a certain weight and size, rendering complex the integration on vehicle's glazing or leading to difficulties to bond the optical wedge element to the glazing. Moreover, due to the thickness of the optical wedge element, it will absorb some part of the signal and will therefore lead in signal attenuation.

The use of an optical wedge element also leads to the modification of the field of view (FOV) of the optical sensor. Usually for a vehicle comprising an optical sensor behind one of its glazing, the manufacturer requires a specific field of view for the optical sensor when placed behind the glazing. This specific FOV is required for the optical sensor to be able to detect object outside of the vehicle as well as to measure the distance between such object and the vehicle. The FOV of the optical sensor is therefore designed based on the FOV specifications from the manufacturer. However, when the optical sensor is placed facing the optical wedge element (and the glazing), its FOV is modified. This modified FOV does not correspond to the requested FOV anymore.

WO2018087223 also discloses the use of a light guide body for a camera (active in the visible wavelength range). Such light guide body also acts as an optical prism, and can be assimilated as an optical wedge element. However the aim of this optical wedge element is to deflect radiation that passes through the vehicle window from the outside and is to be detected by the sensor, such that the working angle of the sensor is enlarged. The region of the vehicle window that is used for detection is then reduced. It therefore allows to use less opaque masking print to conceal the sensors, leading to an improvement of the total light transmittance and the aesthetic appearance of the vehicle window. As mentioned in this document, the larger the wedge angle, the stronger the deflection of the radiation and the more pronounced the effect, though the wedge angle is limited by space requirements. However, the larger the wedge angle, the thicker the optical wedge element and the higher the absorption of the light due to the optical wedge element, leading to less accurate measurements as the camera is receiving less light.

There is therefore a need for an optical wedge element correcting the drawbacks of the optical wedge elements known from the prior art and answering the requirements from the vehicle manufacturers.

### SUMMARY OF THE INVENTION

The present invention concerns a glazing having an internal and an external face. The glazing comprises an E/R optical sensor facing the internal face of the glazing. The E/R optical sensor has an intrinsic field of view α. The glazing also comprises an optical wedge element, also having an internal and an external face. The optical wedge element is placed between the internal face of the glazing and the E/R optical sensor. The external face of the optical wedge element faces the internal face of the glazing. The internal and the external faces form a wedge angle γ. The glazing is placed at an installation angle τ with the horizontal plane at the region where the E/R optical sensor faces the internal face of the glazing. The scaling factor

$$S = \frac{α}{β} < 1 ,$$

where β is the field of view of the E/R optical sensor placed on the internal face of the glazing. A maximal angle of incidence ιₘₐₓ of a signal emitted by the E/R optical sensor on the internal face of the optical wedge element is set at a value of 60°, more preferably 50°, even more preferably 40°. The wedge angle γ is equal to a value for which the intersection of the field of view α of the E/R optical sensor with the internal face of the optical wedge element forms an angle of incidence ι_{L+}, ι_{L-} below or equal to the maximal angle of incidence ιₘₐₓ.

The present invention also concerns the use of a glazing comprising and optical wedge element, as well as a method to determine the optimal wedge angle γ of such optical wedge element.

### BRIEF DESCRIPTION OF THE DRAWINGS

The invention will now be described further, by way of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

FIG. 1 illustrates a 3D view of an optical wedge element according to the present invention placed behind a windshield of a vehicle.

FIGS. 2a and 2b illustrates 2D views of an optical wedge element according to the present invention placed behind a vehicle glazing. FIG. 2b is a magnified view of FIG. 2a. FIG. 2c illustrates an embodiment where the E/R optical sensor is tilted compared to the horizontal plane.

FIG. 3 is a graph of the scaling factor S as a function of the wedge angle for various values of installation angles.

FIG. 4 illustrates the reflection at the interface between material with a refractive index of 1.5 and air based on Fresnel equations.

FIG. 5 illustrates the positive impact of using an optical wedge element according to the invention for a given configuration.

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes a glazing comprising an emitting and receiving (E/R) optical sensor and an optical wedge element placed between the glazing and the E/R optical sensor. The following description focuses on the case of a vehicle glazing, but the invention can be applied to an optical wedge element placed on any kind of glazing.

Vehicle glazing refers to any conventional window of a vehicle, such as a windshield, a rearlite or a sidelite (including quarter lite). Basically, such vehicle glazing is provided for separating a vehicle interior from outer surroundings. But it can also refer to any other external part of the vehicle as long as it is transparent to the wavelength range of the E/R optical sensor. For example, the E/R optical sensor can be placed inside the headlight compartment. In this case, the glazing refers to the transparent piece forming the headlight. Another example would be an E/R optical sensor placed behind one of the pillar of the automotive vehicle. In this case, the glazing refers to the piece put in front of the E/R optical sensor as a pillar cover.

The vehicle glazing comprises at least one pane. The face of the at least one pane facing the outer surroundings of the vehicle in the installed position is referred to as the “external face”. The face of the at least one pane facing the interior of the vehicle in the installed position is referred as the “internal face”. The same wording is used to describe the faces of the optical wedge element: “external face” refers to the face in contact with the internal face of the glazing, while “internal face” refers to the face in front of the E/R optical sensor.

The vehicle glazing be made of glass (monolithic glass) or plastics, or a combination thereof (such as a laminated glass), as long as the glazing is transparent at the operating wavelength range of the E/R optical sensor. The glazing can be flat or bent. It can also present a different curvature in the upper part than in the lower part, such as a car's windshield for example.

An E/R optical sensor refers to emitting and receiving optical sensors, such as a lidar or a radar. In the case of a lidar, it firstly emits IR light from the inside of the vehicle towards the outside of the vehicle. The IR light is then reflected by an object outside of the vehicle back to the sensor, which is then able to evaluate the distance between the vehicle and the said object.

The optical wedge element can be made of glass or plastics such as polyvinyl butyral (PVB), polyurethane (PU), polymethylmethacrylate (PMMA), polycarbonate (PC) or optical silicon. It can also be made of a combination of these materials. Basically, the optical wedge element can be made of any material as long as it is transparent at the operating wavelength range of the E/R optical sensor. It must also present a refractive index close to the refractive index of the glazing for the purpose of the present invention. The optical wedge element can also be coated with antireflective coating in order to decrease the reflection on its faces. Applying such antireflective coating on the optical wedge element is easier and cheaper than on the whole surface of glazing as discussed compared to the prior art. Furthermore, standard AR coating designed for normal incidence can be used, as the angle of incidence is kept below a defined value (described later in the present description). Additional functions can be added to this optical wedge element, such as a heating coating or a silverprint. The optical wedge element can be attached to the vehicle glazing by gluing, autoclaving, mechanical clipping, laser welding, optical coupling or any other method known by the skilled in the art.

The wedge angle γ is the angle formed by the external face of the optical wedge element with its internal face.

The installation angle τ is the angle formed by the vehicle glazing with the horizontal plane at the region of the glazing where the E/R optical sensor faces the internal face of the glazing.

### FOV Scaling

Usually for a vehicle comprising an E/R optical sensor behind at least one of its glazing, the manufacturer requires a specific field of view (FOV) for the E/R optical sensor when placed behind the glazing. This specific FOV is required for the E/R optical sensor to be able to detect object outside of the vehicle as well as to measure the distance between such object and the vehicle. This requested FOV is different than the intrinsic FOV of the E/R optical sensor, as the rays have to pass through the glazing and will therefore encounter refraction. The requested FOV is therefore always bigger than the intrinsic FOV of the E/R optical sensor. The scaling factor S determines the factor between the intrinsic FOV and the requested FOV:

$$S = \frac{{FOV}_{intrinsic}}{{FOV}_{requested}}$$

The intrinsic FOV is specific to the E/R optical sensor. Using ray-tracing simulation method, it is possible to determine the scaling factor S based on the installation angle, the wedge angle and the refractive indexes of the glazing and the optical wedge element.

Basically, the intrinsic FOV of the E/R optical sensor should be as small as possible. This way the sensor zone on the glazing, meaning the zone in the glazing where the rays travel from or to the E/R optical sensor (and being transparent to the working wavelength range of the E/R optical sensor), can be relatively small. As this sensor zone is small, then the optical wedge element thickness can also be reduced, leading to less absorption as well as an easier integration on the glazing.

The intrinsic FOV of the optical sensor needs to be scaled and the signal distribution needs to be redistributed so that the requested FOV (after the vehicle glazing equipped with the optical wedge element) obeys to the requested configuration from the vehicle manufacturer. Usually, only by playing with the inclination of the E/R optical sensor and the wedge angle of the optical wedge element, the requested FOV can be adjusted to the requested configuration. However, an additional corrective optical element, such as a distortion lens, could also be added between the E/R optical sensor and the optical wedge element, in order to rescale the size and the signal distribution of the intrinsic FOV.

### Maximal Angle of Incidence on the Internal Surface of the Optical Wedge Element

The angle of incidence ι is the angle of incidence of the signal of the E/R optical sensor at the internal face of the optical wedge element. As known by the skilled in the art, the smaller the angle of incidence, the less reflection occurs, leading to higher transmission of the rays.

Based on Fresnel equations, and knowing the refractive index of both the glazing and the optical wedge element, the reflection can be calculated depending on the angle of incidence. Depending on the minimal transmission needed for the E/R optical sensor to operate with sufficient accuracy, the maximal reflection can be estimated. To this maximal reflection corresponds a maximal angle of incidence ιₘₐₓ, which is the maximal angle of incidence on the internal surface of the optical wedge element.

The maximal angle of incidence ιₘₐₓ is set at a value of 60°, more preferable 50°, even more preferably 40°

### Minimal Wedge Angle

The wedge angle γ for which the intersection of the intrinsic FOV of the E/R optical sensor with the internal face of the optical wedge element forms an angle of incidence below or equal to the maximal angle of incidence ιₘₐₓ is determined. Choosing the lowest wedge angle γ will render the optical wedge element as thin as possible, and will therefore lead to less absorption from the material of the optical wedge element, and then higher transmission.

The present invention also concerns the use of a glazing comprising an optical wedge element to reduce the reflection of the signal from the E/R optical sensor at the internal face of the glazing.

The present invention also concerns a method to determine the optimal wedge angle of an optical wedge element placed on the internal face of a glazing, the internal face of the optical wedge element facing an E/R optical sensor.

### Example

In the following example, the invention is explained in detail with reference to drawings (exemplary embodiment). The drawings are a schematic representation and not to scale. The drawings in no way restrict the invention.

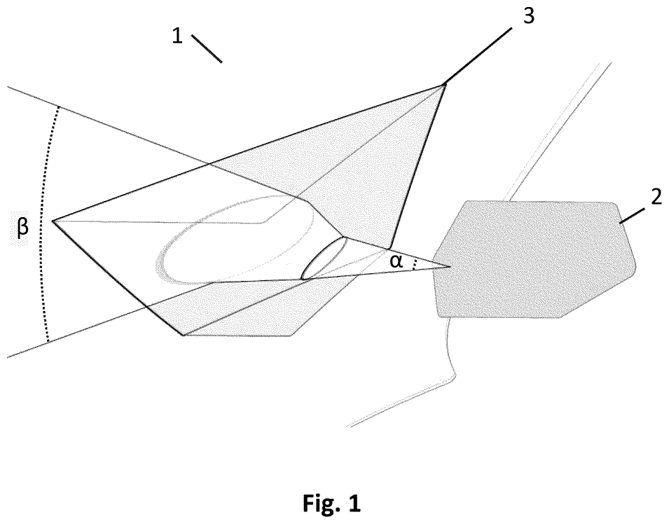

FIG. 1 is a 3D view of a vehicle glazing (1) (in this case a windshield) with an E/R optical sensor (2) facing the vehicle glazing (1). An optical wedge element (3) is placed between the vehicle glazing (1) and the E/R optical sensor (2). As can be seen both the intrinsic FOV (a) and the requested FOV (B) are conical. However, for clarity of explanation, the following description will be done based on 2D figures, but the reasoning is the same.

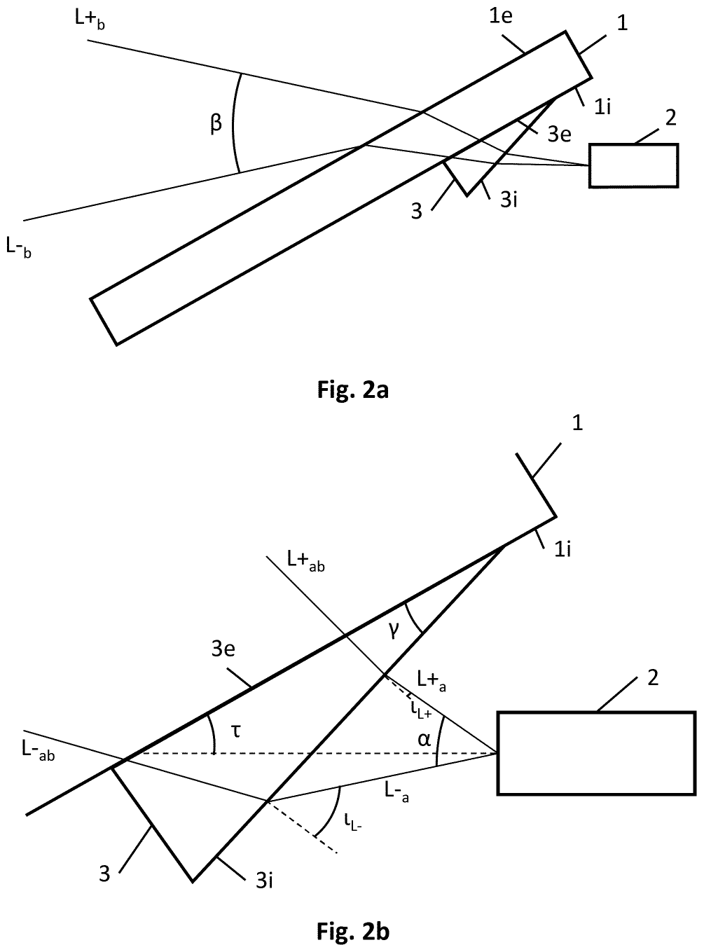

FIG. 2a depicts a vehicle glazing (1) with an E/R optical sensor (2) facing the internal face (1i) of the vehicle glazing (1). An optical wedge element (3) is placed between the vehicle glazing (1) and the E/R optical sensor (2). The external face (3e) of the optical wedge element (3) and the internal face (1i) of the glazing (1) are matched to each other. In this example, both the glazing (1) and the optical wedge element (3) have the same refractive index of 1.5.

The requested FOV (B) is represented by its extremal rays (L_{-b}, L_{+b}) forming the limits of this FOV in the vertical plane. In this example, the requested FOV (B) is equal to 30°. The extremal rays (L_{-b}, L_{+b}) are respectively at −15° and +15°, symmetrically compared to the centre of the requested FOV (B) which in this example is horizontal.

FIG. 2b depicts the same vehicle glazing (1) with the same E/R optical sensor (2), including the same optical wedge element (3) at a higher magnification for clarity of the description. It also shows the angle of installation (t) which corresponds to the angle formed by the vehicle glazing (1) with the horizontal plane at the region where the E/R optical sensor (2) is placed near the vehicle glazing (1). In this example, the E/R optical sensor (2) is place horizontally, but it could be tilted compared to the vehicle glazing (1), as shown in FIG. 2c.

The intrinsic FOV (a) of the E/R optical sensor (2) is also represented by its extremal rays (L₋ₐ, L₊ₐ) forming the limits of this FOV in the vertical plane. The angles of incidence (ι_{L-}, ι_{L-}) of the extremal rays (L₋ₐ, L₊ₐ) of the intrinsic FOV (α) with the internal face (3i) of the optical wedge element (3) are also depicted.

The wedge angle (γ) is the angle formed by the external face (3e) and the internal face (3i) of the optical wedge element (3).

The scaling factor is given by the following expression:

$$S = \frac{α}{β} < 1$$

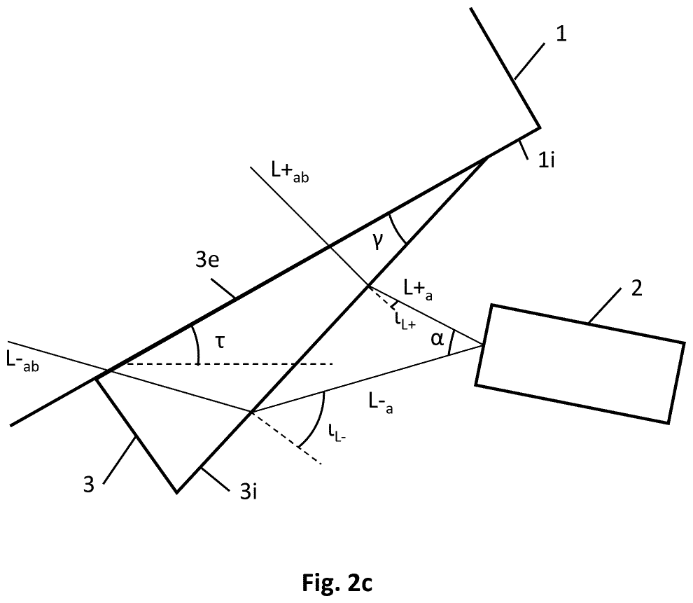

FIG. 3 shows the scaling factor S as a function of the wedge angle (γ) for various values of installation angles (τ). As the installation angle (τ) increases, the scaling factor S increases as well. For a fixed installation angle (τ)≤40°, the scaling factor S decreases with the increasement of the wedge angle (γ) (up to 30°): the bigger the wedge angle (γ), the smaller the intrinsic FOV (α). Besides, for a fixed installation angle (τ)>40°, the scaling factor S reaches a minimal value for a wedge angle (γ)<30°. This means that the design should approach this wedge angle (γ) as much as possible, to have a minimal intrinsic FOV (α).

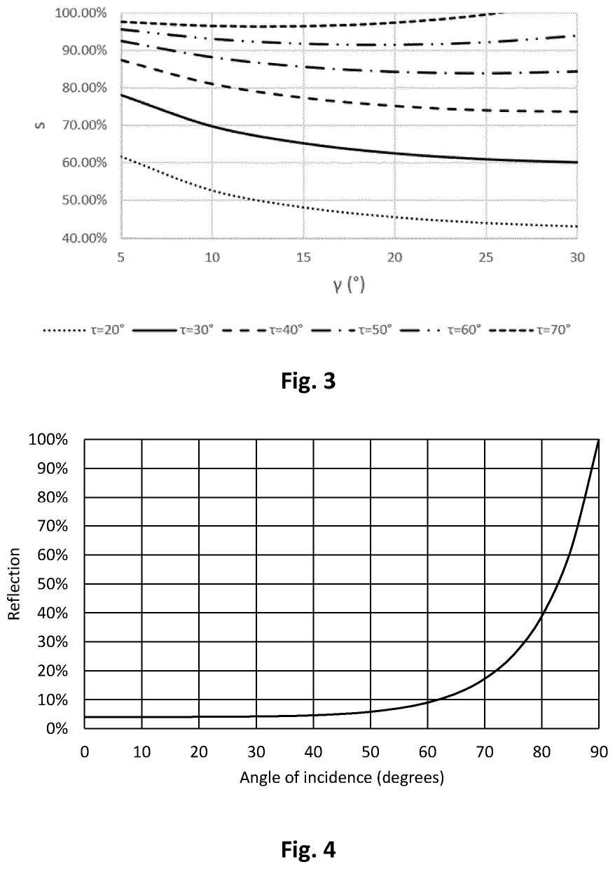

The value of the maximal angle of incidence (ιₘₐₓ) on the internal surface (3i) of the optical wedge element (3) is 60°, more preferably 50°, even more preferably 40°. Based on Fresnel equations, FIG. 4 shows the reflection at the interface between material with a refractive index of 1.5 and air. Let's assume the maximal reflection value is fixed at 5%. This value is chosen as an example, and may differ depending on the E/R optical sensor sensitivity. This value corresponds to an angle of incidence (ιₘₐₓ) lower than 40°. This means that the E/R optical sensor receives sufficient transmission for accurate measurement as long as the angle of incidence (t) on the internal surface (3i) of the optical wedge element (3) is below 40°.

Table 1 shows the values of the angles of incidence (ι_{L+}, ι_{L-}) corresponding, respectively, to the angles of incidence of the extremal rays (L₊ₐ, L₋ₐ) of the intrinsic FOV (α) with the internal face (3i) of the optical wedge element (3), for several values of wedge angle (γ) depending on the installation angle (τ). For this example, the values below 40°, as defined previously, have been highlighted in bold.

TABLE 1

| Installation | Wedge | Angle of | Angle of |
|---|---|---|---|
| angle τ | angle γ | incidence ι_{L+} | incidence ι_{L-} |
| 20 | 0 | 55 | 85 |
| | 5 | 44.9 | 63.4 |
| | 10 | 36.0 | 51.8 |
| | 15 | 27.7 | 42.1 |
| | 20 | 19.8 | 33.4 |
| | 25 | 12.1 | 25.3 |
| | 30 | 4.5 | 17.5 |
| 30 | 0 | 45 | 75 |
| | 5 | 36.1 | 59.5 |
| | 10 | 27.8 | 48.7 |
| | 15 | 19.9 | 39.4 |
| | 20 | 12.2 | 30.9 |
| | 25 | 4.6 | 22.9 |
| | 30 | 2.9 | 15.1 |
| 40 | 0 | 35 | 65 |
| | 5 | 26.8 | 53.0 |
| | 10 | 18.9 | 43.2 |
| | 15 | 11.2 | 34.4 |
| | 20 | 3.7 | 26.2 |
| | 25 | 3.9 | 18.3 |
| | 30 | 11.4 | 10.7 |
| 50 | 0 | 25 | 55 |
| | 5 | 17.2 | 44.9 |
| | 10 | 9.5 | 36.0 |
| | 15 | 2.0 | 27.7 |
| | 20 | 5.5 | 19.8 |
| | 25 | 13.1 | 12.1 |
| | 30 | 20.8 | 4.5 |
| 60 | 0 | 15 | 45 |
| | 5 | 7.4 | 36.1 |
| | 10 | 0.1 | 27.8 |
| | 15 | 7.7 | 19.9 |
| | 20 | 15.3 | 12.2 |
| | 25 | 23.0 | 4.6 |
| | 30 | 31.1 | 2.9 |
| 70 | 0 | 5 | 35 |
| | 5 | 2.5 | 26.8 |
| | 10 | 10.1 | 18.9 |
| | 15 | 17.7 | 11.2 |
| | 20 | 25.5 | 3.7 |
| | 25 | 33.7 | 3.9 |
| | 30 | 42.4 | 11.4 |

The lowest wedge angle (γ) is equal to the value for which the intersection of the intrinsic FOV (α) of the E/R optical sensor (2) with the internal face (3i) of the optical wedge element (3) forms an angle of incidence (ι_{L+}, ι_{L-}) below to the maximal angle of incidence (ιₘₐₓ) defined previously, 40° in this example.

Table 2 shows the optimal values of the wedge angle (γ) depending on the installation angle (τ). The smallest values of the wedge angle (γ) have been chosen from the Table 1, amongst the highlighted bold ones.

TABLE 2

| Installation angle τ | Optimal wedge angle γ |
|---|---|
| 20 | 20 |
| 30 | 15 |
| 40 | 15 |
| 50 | 10 |
| 60 | 5 |
| 70 | 0 |

### Comparative Example

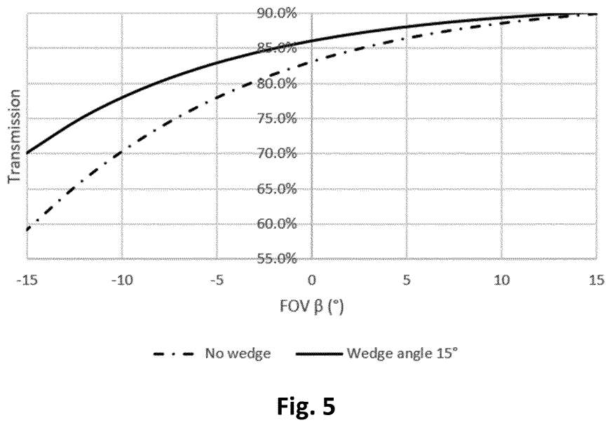

Based on the previous example and on the fact that the materials of both the glazing (1) and the optical wedge element (3) have very low absorption coefficients (below 0.01 cm⁻¹), FIG. 5 shows the total transmission within the requested FOV (β), with and without an optical wedge element (3) with a wedge angle (γ) of 15° for an installation angle (τ) of 30°. Thanks to the optical wedge element (3) with the optimal value of the wedge angle (γ) as defined previously, the transmission can be increased up to 10%, which is very significative in the automotive industry.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1. A glazing having an internal face and an external face comprising:
a. an emitting and receiving optical sensor facing the internal face of the glazing, having an intrinsic field of view;
b. an optical wedge element having an internal face and an external face, placed between the internal face of the glazing and the emitting and receiving optical sensor, the external face of the optical wedge element being faced to the internal face of the glazing, the internal face and the external face of the wedge element forming a wedge angle (γ);
wherein the glazing is placed at an installation angle (τ) with a horizontal plane at a region where the emitting and receiving optical sensor faces the internal face of the glazing;
wherein a scaling factor
$$S = \frac{α}{β} < 1 ,$$
where β is a requested field of view of the emitting and receiving optical sensor placed on the internal face of the glazing; and
wherein
i. a maximal angle of incidence (ιₘₐₓ) of a signal emitted by the emitting and receiving optical sensor on the internal face of the optical wedge element is set at a value of 60°;
ii. the wedge angle (γ) is equal to a value for which an intersection of the intrinsic field of view (α) of the emitting and receiving optical sensor with the internal face of the optical wedge element forms an angle of incidence (ι_{L+}, ι_{L-}) below or equal to the maximal angle of incidence (ιₘₐₓ).

2. The glazing according to claim 1, wherein the wedge angle (γ) is a lowest value for which the intersection of the field of view (α) of the emitting and receiving optical sensor with the internal face of the optical wedge element forms an angle of incidence (ι_{L+}, ι_{L-}) below or equal to the maximal angle of incidence (ιₘₐₓ).

3. The glazing according to claim 1, wherein the optical wedge element is made of glass or plastics.

4. The glazing according to claim 1, wherein the internal face of the optical wedge element is coated with an antireflective coating.

5. The glazing according to claim 1, wherein the optical wedge element is fixed to the glazing by gluing, autoclaving, mechanical clipping, laser welding or optical coupling.

6. The glazing according to claim 1, wherein the emitting and receiving optical sensor is a lidar.

7. The glazing according to claim 1, wherein the glazing further comprises an additional corrective optical element between the emitting and receiving optical sensor and the optical wedge element, adapted to rescale a size and a signal distribution of the intrinsic field of view (α) of the emitting and receiving optical sensor.

8. The glazing according to claim 1, wherein the glazing is an automotive glazing.

9. The glazing according to claim 8, wherein the glazing is a windshield or a rear lite.

10. The glazing according to claim 1, wherein the glazing is made of glass or plastics or a combination thereof.

11. The glazing according to claim 1, wherein the glazing is a laminated glazing.

12. The glazing according to claim 1, wherein the glazing has a value of transmission above 90% at the operating wavelength range of the emitting and receiving optical sensor.

13. The glazing according to claim 1, wherein the optical wedge element has a value of transmission above 90% at an operating wavelength range of the emitting and receiving optical sensor.

14. (canceled)

15. A method for determining an optimal wedge angle (γ) formed by an internal face and an external face of an optical wedge element;
wherein the optical wedge element is placed on an internal face of a glazing having an internal face and an external face, the external face of the optical wedge element being faced to the internal face of the glazing;
wherein the internal face of the optical wedge element faces an emitting and receiving optical sensor, the emitting and receiving optical sensor having an intrinsic field of view (α);
wherein the vehicle glazing forms an installation angle (τ) with a horizontal plane at a region where the emitting and receiving optical sensor is placed near the glazing;
the method comprising:
a. determining a scaling factor S based on the installation angle (τ), where
$$S = \frac{α}{β} < 1 ,$$
where β is a field of view of the emitting and receiving optical sensor placed on the internal face of the vehicle glazing;
b. determining a maximal angle of incidence (ι) at the internal face of the optical wedge element based on a maximal defined reflection;
c. determining a lowest wedge angle (γ) for which the intersection of the intrinsic field of view (α) of the emitting and receiving optical sensor with the internal face of the optical wedge element forms an angle of incidence (ι_{L+}, ι_{L-}) below or equal to the maximal angle of incidence (ι).

16. The glazing according to claim 1, where the maximal angle of incidence (ιmax) of the signal emitted by the emitting and receiving optical sensor on the internal face of the optical wedge element is set at a value of 50°.

17. The glazing according to claim 1, where the maximal angle of incidence (ιmax) of the signal emitted by the emitting and receiving optical sensor on the internal face of the optical wedge element is set at a value of 40°.

18. The glazing according to claim 3, wherein the optical wedge element is made of a material selected from the group consisting of polyvinyl butyral (PVB), polyurethane (PU), polymethylmethacrylate (PMMA), polycarbonate (PC), optical silicon, and a combination thereof.

19. The glazing according to claim 7, wherein the corrective optical element is a distortion lens.
